(19) United States
(12) Patent Application Publication
(10) Pub. No.: US 2026/0239361 A1
(43) Pub. Date: Aug. 13, 2026

(54) METHODS AND APPARATUS FOR DOWNLINK DECODING FEEDBACK IN WIRELESS SYSTEMS

(71) Applicant: InterDigital Patent Holdings, Inc., Wilmington, DE (US)

(72) Inventors: Aata El Hamss, Laval (CA); Paul Marinier, Brossard (CA); Tao Deng, New York, NY (US); Loic Canonne-Velasquez, Dorval (CA); Nazli Khan Beigi, Longueuil (CA); Remun Koirala, London (GB); Haseeb Ur Rehman, Winnipeg (CA); Faris Alfarhan, Montreal (CA); Moon IL Lee, Melville, NY (US); Ghyslain Pelletier, Montreal (CA)

(73) Assignee: InterDigital Patent Holdings, Inc., Wilmington, DE (US)

(21) Appl. No.: 19/053,109

(22) Filed: Feb. 13, 2025

(51) Int. Cl. H04W 72/23; H04L 1/1812; H04W 24/10

(52) U.S. Cl. CPC H04W 72/23; H04L 1/1812; H04W 24/10

(57) ABSTRACT

A method for use by a wireless transmit/receive unit (WTRU) may comprise: receiving a downlink transmission, decoding the downlink transmission, and determining downlink decoding information (DDI) of the decoded downlink transmission. The DDI may include at least a transmission time of the received downlink transmission. The method may comprise determining to send a DDI report based on at least a priority associated with the downlink transmission. The DDI report may comprise the DDI. The method may comprise: sending a request for uplink resources for sending the DDI report, receiving an allocation of uplink resources for sending the DDI report, and sending the DDI report in the allocated uplink resources. The determining to send the DDI report may be further based on a number of retransmissions of the downlink transmission; channel conditions during the downlink transmission; a received indication requesting the DDI report; or a downlink transmission decoding outcome.

### BACKGROUND

Hybrid automatic repeat request (HARQ) protocol comprises acknowledging a decoding status of a transmission to efficiently enable possible retransmission of the same data, instead of blind repetitions of the same data. The retransmitted data may be combined with a previous transmission of the same data to maximize the probability of successfully decoding the data. In New Radio (NR) and Long Term Evolution (LTE), a wireless transmit/receive unit (WTRU) may report, to a gNB, whether the decoding of a received transport block has succeeded or not (e.g., acknowledgement (ACK)/negative acknowledgment (NACK) value). In case an ACK is received, the gNB may use a HARQ process identification (ID) for a new data transmission and may request the WTRU to flush the HARQ buffer for the positively acknowledged HARQ process. In case a NACK is received, the gNB may retransmit the same data in another transmission and indicate to the WTRU how to combine the retransmission with a previous transmission (indication of the applicable redundancy version (RV)). The gNB may keep sending retransmissions until a positive HARQ-ACK feedback is received or the gNB may decide to stop retransmission and use the HARQ process for new data.

### SUMMARY

A method for use by a wireless transmit/receive unit (WTRU) may comprise receiving a downlink transmission. The method may comprise decoding the downlink transmission. The method may comprise determining downlink decoding information (DDI) of the decoded downlink transmission. The DDI may include at least a transmission time of the received downlink transmission. The method may comprise determining to send a DDI report based on at least a priority associated with the downlink transmission. The DDI report may comprise the DDI. The method may comprise sending a request for uplink resources for sending the DDI report. The method may comprise receiving an allocation of uplink resources for sending the DDI report. The method may comprise sending the DDI report in the allocated uplink resources. The downlink transmission may be received over a physical downlink shared channel (PDSCH), a physical downlink control channel (PDCCH), or a physical broadcast channel (PBCH). The determining to send the DDI report may be based on a condition that the priority associated with the downlink transmission is above a configured threshold. The determining to send a DDI report may be further based on at least one of: a number of retransmissions of the downlink transmission; channel conditions during the downlink transmission; a received indication requesting the DDI report; a downlink transmission decoding outcome; a measured signal to interference plus noise ratio (SINR) during the downlink transmission being greater than a first threshold value; or a number of retransmissions associated with a HARQ process identification (ID) being less than a second threshold. The method may comprise receiving a downlink control information (DCI) that schedules the downlink transmission. The DDI may further include at least one of: hybrid automatic repeat request (HARQ) acknowledgment information regarding the downlink transmission; a HARQ process identification (ID); a new data indicator; or a measurement of the downlink transmission. The transmission time of the received downlink transmission may comprise an offset from a reference slot. The method may comprise storing the DDI based on one or more of: whether the downlink transmission is control information; a priority of the downlink transmission; a number of retransmissions of the downlink transmission; channel conditions during the downlink transmission; or whether a DDI value is within a configured range. The method may comprise receiving a plurality of downlink transmissions and grouping a decoding status of the plurality of downlink transmissions into a single DDI. The method may comprise determining an importance of a DDI, based on at least one of: a latency budget, a priority of received data, a decoding error rate, a number of decoding errors, an application associated with the received data, an importance indication of a received transport block, code block, or code block group; or whether HARQ is enabled or disabled; and wherein the determining to send the DDI report is further based on the determined importance of the DDI.

A wireless transmit/receive unit (WTRU) may comprise a receiver, a transmitter, and a processor. The receiver may be configured to receive a downlink transmission. The processor may be configured to decode the downlink transmission. The processor may be further configured to determine downlink decoding information (DDI) of the decoded downlink transmission. The DDI may include at least a transmission time of the received downlink transmission. The processor may be further configured to determine to send a DDI report based on at least a priority associated with the downlink transmission. The DDI report may comprise the DDI. The transmitter may be configured to send a request for uplink resources for sending the DDI report. The receiver may be further configured to receive an allocation of uplink resources for sending the DDI report. The transmitter may be further configured to send the DDI report in the allocated uplink resources. The downlink transmission may be received over a physical downlink shared channel (PDSCH), a physical downlink control channel (PDCCH), or a physical broadcast channel (PBCH). The processor may be further configured to determine to send the DDI report is based on a condition that the priority associated with the downlink transmission is above a configured threshold. The processor may be configured to determine to send a DDI report further based on at least one of: a number of retransmissions of the downlink transmission; channel conditions during the downlink transmission; a received indication requesting the DDI report; a downlink transmission decoding outcome; a measured signal to interference plus noise ratio (SINR) during the downlink transmission being greater than a first threshold value; or a number of retransmissions associated with a HARQ process identification (ID) being less than a second threshold. The receiver may be further configured to receive a downlink control information (DCI) that schedules the downlink transmission. The DDI may further include at least one of: hybrid automatic repeat request (HARQ) acknowledgment information regarding the downlink transmission; a HARQ process identification (ID); a new data indicator; or a measurement of the downlink transmission. The transmission time of the received downlink transmission may comprise an offset from a reference slot. The processor may be further configured to store the DDI based on one or more of: whether the downlink transmission is control information; a priority of the downlink transmission; a number of retransmissions of the downlink transmission; channel conditions during the downlink transmission; or whether a DDI value is within a configured range. The receiver may be further configured to receive a plurality of downlink transmissions. The processor may be further configured to group a decoding status of the plurality of downlink transmissions into a single DDI. The processor may be further configured to determine an importance of a DDI, based on at least one of: a latency budget, a priority of received data, a decoding error rate, a number of decoding errors, an application associated with the received data, an importance indication of a received transport block, code block, or code block group; or whether HARQ is enabled or disabled. The processor may be further configured to determine to send the DDI report based on the determined importance of the DDI.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example procedure for downlink decoding information (DDI); and

FIG. 3 shows an example procedure for downlink decoding information (DDI).

### DETAILED DESCRIPTION

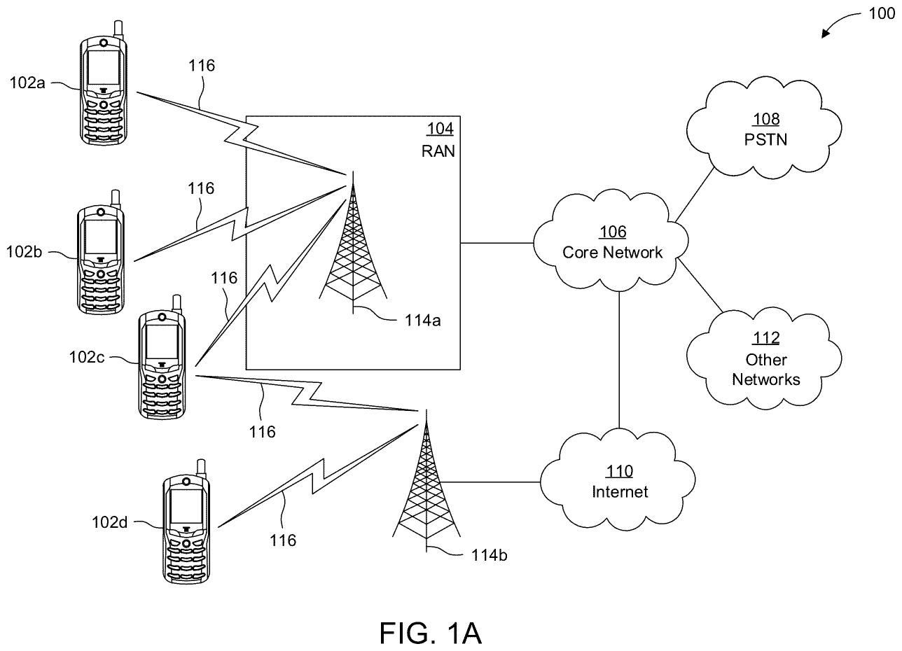

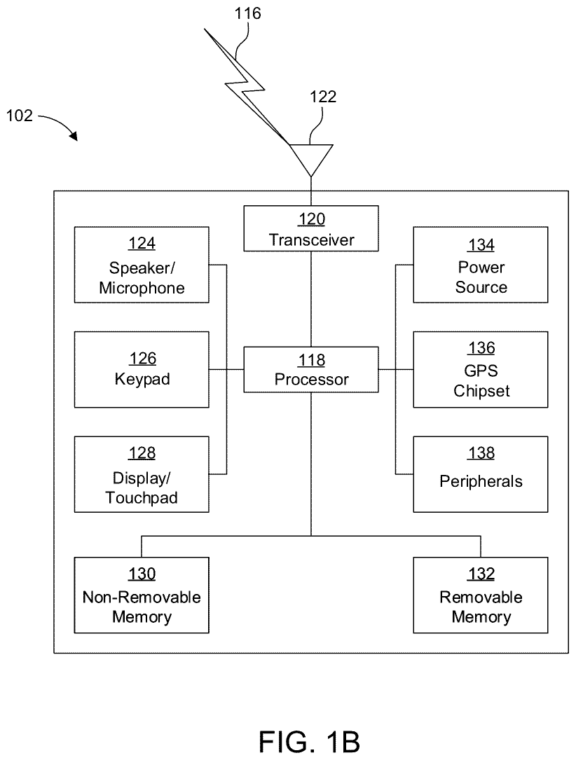

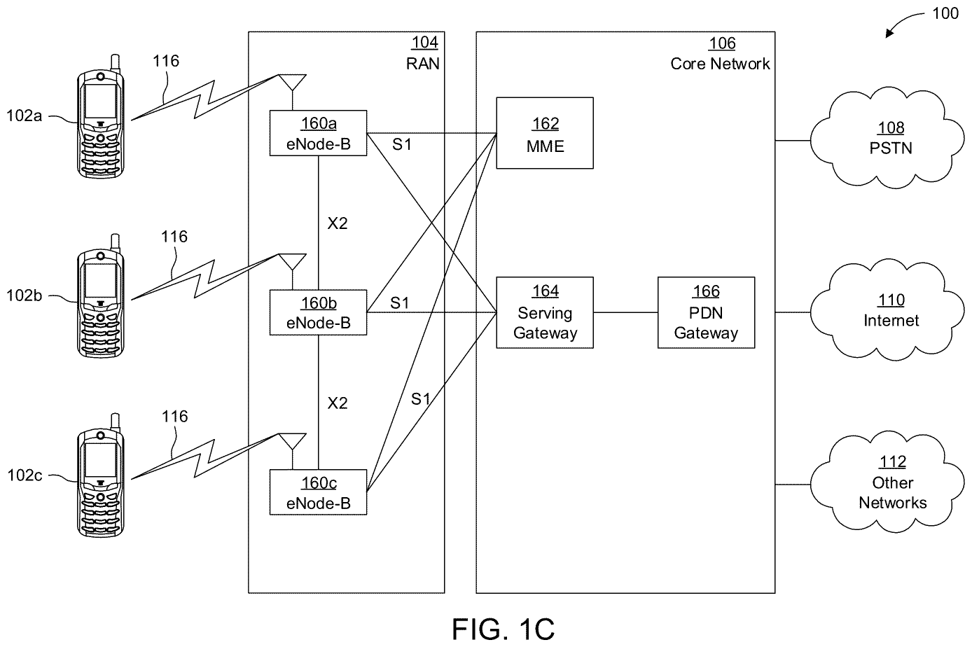

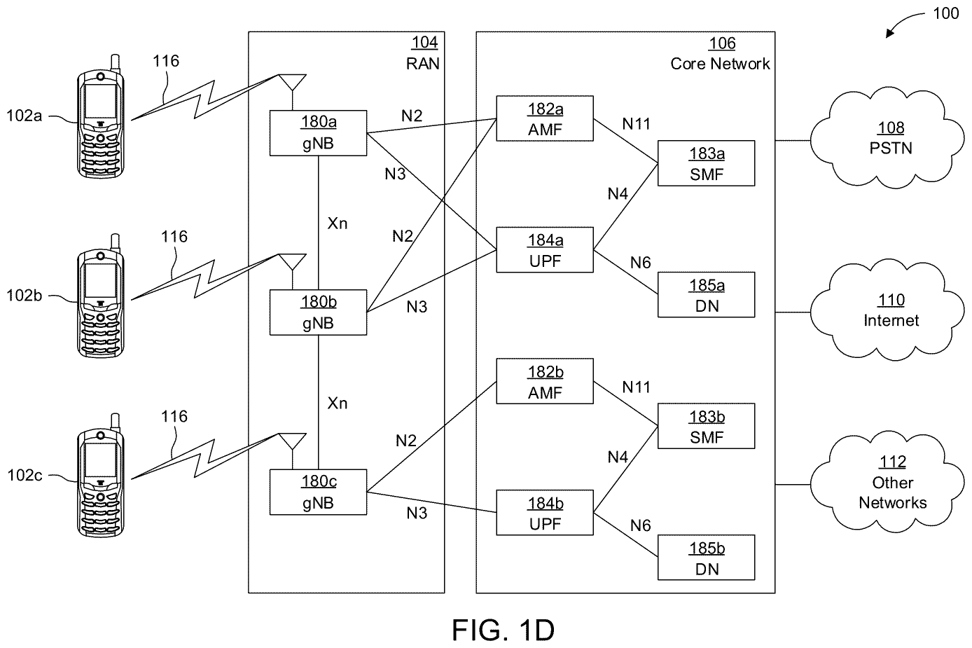

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the uplink (UL) (e.g., for transmission) and downlink (DL) (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may receive an indication regarding when to send a HARQ-ACK feedback to a gNB. Multiple HARQ-ACK feedback for different data transmission may be sent together by the WTRU using the same uplink resource. In NR, grouping the different HARQ-ACK feedback may be done using three main approaches. For semi-static HARQ-ACK feedback grouping, the WTRU may send the HARQ-ACK feedback for all the possible downlink transmission opportunities regardless of whether a transmission occurred or not. This approach requires high uplink payload. For dynamic HARQ-ACK feedback grouping, the WTRU may send the HARQ-ACK feedback for only scheduled downlink transmissions. This approach may suffer from DCI miss-detection and may result in inaccurate size of the HARQ-ACK feedback. For one-shot HARQ-ACK feedback grouping, the WTRU may send the HARQ-ACK feedback for all or a sub-set of HARQ processes. This approach also requires high uplink payload.

Other information may also be beneficial for the gNB to allow more efficient ways of retransmission. For example, a soft HARQ feedback with more information such as channel state information (CSI) measurements/prediction may help the scheduler to select the appropriate redundancy version (RV), modulation and coding scheme (MCS) and resource block (RB) allocation for the retransmission to maximize the probability of successfully decoding.

In NR, HARQ feedback timing may restrict the scheduling flexibility of the gNB. The dependency between the physical downlink shared channel (PDSCH) scheduling time and the HARQ ACK feedback time may restrict the gNB subsequent scheduling decisions. Furthermore, in some scenarios, sending HARQ ACK feedback may be skipped (e.g., decoding succeeded or bad channel conditions which does lead to successful transmission even after retransmissions). In other cases, reporting only ACK/NACK may not be helpful to assist the scheduler to better select the retransmission parameters. A problem is how to remove the timing restriction between a PDSCH transmission and a HARQ-ACK transmission and how to add more decoding information to the HARQ feedback report.

In an embodiment, a WTRU may determine whether or not to report downlink decoding information (DDI) (e.g., HARQ ACK) of a downlink transmission based on, for example a transmission priority, a number of retransmissions, and/or channel conditions during the transmission. The WTRU may request an uplink resource to transmit the DDI report.

A WTRU may receive a downlink control information (DCI) that schedules a downlink transmission. The WTRU may receive the DCI from a network node (e.g., base station or gNB). The WTRU may receive the scheduled downlink transmission. The WTRU may decode the received downlink transmission. The WTRU may determine downlink decoding information (DDI). The DDI may include one or more of the following: HARQ-ACK of the received downlink transmission; a HARQ process identification (ID); a new data indicator (NDI) of the received downlink transmission; a transmission time of the received downlink transmission (e.g., offset from a reference slot); at least one measurement (e.g., channel quality indicator (CQI), signal to interference plus noise ratio (SINR), reference signal received power (RSRP)) of the downlink transmission, or a portion of the downlink transmission (e.g., PDSCH demodulation reference signal (DMRS)) or another downlink transmission (e.g., a channel state information (CSI)-reference signal (RS) that may be near in time and/or frequency of the downlink transmission).

The WTRU may determine whether to report the DDI to the gNB based one or more of the following conditions. The WTRU may determine whether to report the DDI based on whether the WTRU receives an indication from the gNB requesting the DDI report (e.g., an indication in the DCI scheduling downlink the transmission or other DCI). The WTRU may determine whether to report the DDI based a decoding outcome (e.g., HARQ ACK or HARQ NACK) of the downlink transmission. The WTRU may determine whether to report the DDI based on whether a measured SINR during the transmission is above a configured threshold value. The WTRU may determine whether to report the DDI based on whether a number of retransmissions for the HARQ process ID is below a configured threshold. The WTRU may determine whether to report the DDI based on whether a priority associated with the received downlink transmission is above threshold.

If the WTRU receives an indication from the gNB to report DDI and the gNB provided an uplink resource for the DDI report (e.g. in a DCI), the WTRU may transmit the DDI report using the configured uplink resource. Otherwise, if the WTRU does not receive an indication or resource from the gNB to report the DDI and the WTRU determined to report the DDI, the WTRU may: request an uplink resource to transmit DDI report; receive a DCI scheduling an uplink resource for reporting the DDI report; and transmit the DDI report in the scheduled uplink resource for the DDI report.

The WTRU may report the downlink decoding information (DDI), which may help the network scheduler for future transmissions/retransmissions and may reduce the overhead in the uplink resources. The above procedure removes the timing relationship between the scheduling time and the HARQ feedback reporting.

In the following embodiments, a downlink decoding information (DDI) may refer to HARQ feedback, CSI report or any type of uplink control information.

In the following embodiment, successfully decoding a transmission refers to a WTRU correctly decoding the transmission. Failure to decode a transmission refers to a WTRU not able to correctly decode the transmission. The WTRU determines whether a transmission is correctly decoded or not based on error detection codes/procedures. For example, the gNB may use a cyclic redundancy check (CRC) bit(s) attached to or included in the downlink transmission information before using channel coding (e.g., low-density parity check (LDPC) code). After decoding the received transmission, the WTRU may determine whether the transmission information is correctly decoded if the CRC bit(s) of the decoded transmission match the transmission information (e.g., using checksum).

In some embodiments, the WTRU may be configured to receive a downlink transmission that includes one or multiple parts. The multiple parts of the downlink transmission may be multiplexed using different physical resource blocks (PRBs) and/or symbols. For example, the WTRU may be configured to receive a downlink transmission which may have a first and second part. The first part may be a control information, and the second part may be a data transmission. The first part may be transmitted over a first set of symbols of the downlink transmission while the second part may be transmitted over the remaining symbols of the downlink transmission. Alternatively, the first part may be transmitted over a first set of PRBs of the downlink transmission while the second part may be transmitted over the remaining PRBs of the downlink transmission. The multiple parts of the downlink transmission may include different data transmission. For example, a first part may include a first transport block, and a second part may include a second transport block. Each part of the downlink transmission may be an initial transmission or a retransmission of the transport block. For example, a first part of the downlink transmission may include an initial transmission, and a second part of the downlink transmission may include a retransmission.

In some cases, the multiple parts of the transmission may be parts of the same transport block, for example, a code block of the same transport block (TB) and/or code block group (CBG) of the same TB.

A WTRU may be configured to determine the decoding information of a downlink transmission (i.e., downlink decoding information (DDI) of a received downlink transmission (e.g., dynamically scheduled transmission or semi-persistent scheduled downlink transmission)). The downlink transmission for which the WTRU determines the DDI may be one or more the following: a transmission on a Physical Downlink Shared Channel (PDSCH); a transmission on a Physical Downlink Control Channel (PDCCH); or a transmission on a Physical Broadcast Channel (PBCH).

A similar concept may be used for other link direction (e.g., sidelink decoding information (SDI), uplink decoding information (UDI)). The embodiments described herein may apply to both a DDI, SDI and UDI. For the case of SDI, decoding information related to sidelink transmission may be determined by the WTRU. For the case of UDI, decoding information related to an uplink transmission may be determined by a gNB and potentially transmitted to a WTRU (i.e., WTRU receives UDI from the gNB).

A WTRU may be configured to identify a downlink decoding information (DDI) with an identification (ID). For example, the WTRU may add a DDI ID to the DDI. The DDI ID may identify a particular DDI which is helpful if, for example, a DDI report includes multiple DDIs. Each ID may refer to a DDI. The WTRU may receive an indication from the network to use an ID value for a DDI. Such indication may be dynamically indicated or semi-statically configured. In an embodiment, the WTRU may receive an explicit indication of the ID corresponding to a DDI (e.g., a bitfield in the DCI indicating the DDI ID for a downlink transmission). In another embodiment, the WTRU may receive an implicit indication of the ID corresponding to a DDI. For example, the WTRU may determine the DDI ID for a downlink transmission based on another indication of the downlink transmission parameters. For example, the WTRU may determine the DDI ID based on the HARQ process ID indicated for the downlink transmission. The WTRU may be configured with or receive information of a mapping between a report ID and the DDI ID. A DDI report may be associated with a report ID. A report may include multiple DDIs (e.g., a group of DDIs), where each DDI may be identified by its DDI ID. The report ID may identify the group of DDIs.

In some embodiments, a WTRU may be configured to store (e.g., on its internal memory) a DDI for a received downlink transmission or to store a DDI of a part of a received downlink transmission. In an example, the WTRU may be configured to store the DDI for all the received downlink transmission. In another example, the WTRU may be configured to determine whether or not to store the DDI for a received downlink transmission or part of received downlink transmission based on one or more of the following.

The WTRU may be configured to determine whether or not to store the DDI based on whether the downlink transmission/part of the downlink transmission is a control information (e.g., if the downlink transmission is a control information). For example, the WTRU may receive a downlink transmission which includes control information and data information. The WTRU may then store the DDI of the downlink transmission/part of the transmission.

The WTRU may be configured to determine whether or not to store the DDI based on the priority of the downlink transmission/part of the downlink transmission. For example, the WTRU may receive a downlink transmission which includes high priority data. The WTRU may then store the DDI of the downlink transmission/part of the transmission. The WTRU may be configured to determine the priority of the received transmission/part of the downlink transmission from the control information scheduling the transmission (e.g., a priority bitfield in the DCI scheduling the transmission). In another example, the WTRU may be configured to determine the priority of the received downlink transmission/part of the downlink transmission based on the channel structure of the transmission. For example, a transmission with a smaller number of symbols (e.g., below a pre-configured number of symbols) may be reserved for high priority transmission. In another example, a transmission with a smaller number of PRBs (e.g., below a pre-configured number of PRBs) may be reserved for high priority transmission. The WTRU may be configured with or receive information regarding priorities for which the DDI should be stored.

The WTRU may be configured to determine whether or not to store the DDI based on the number of retransmissions of the downlink transmission/part of the downlink transmission (e.g., how many times the same transmission is retransmitted). For example, when the WTRU receives an initial transmission, the number of retransmissions is equal to or may be set to 0. In another example, when the WTRU receives a first retransmission, the number of retransmissions is equal to or may be set to 1. Each part of the downlink transmission may have a different number of retransmissions (e.g., the gNB may multiplex a retransmission with a new transmission). The WTRU may be configured with a number of retransmissions for which the DDI should be stored. For example, the WTRU may be configured with a maximum number of retransmissions for which the DDI may be stored (e.g., if the number of retransmissions is above the maximum number, the WTRU does not store the DDI).

The WTRU may be configured to determine whether or not to store the DDI based on channel conditions during the transmission. For example, the WTRU may be configured to store the DDI only when the measured channel conditions during the transmission is above a configured threshold (i.e., in good channel conditions the WTRU stores the DDI). In another example, the WTRU may be configured to store the DDI only when the measured channel conditions during the transmission is below a configured threshold (i.e., in bad channel conditions the WTRU stores the DDI).

The WTRU may be configured to determine whether or not to store the DDI based on whether a DDI value is in a configured value/range. When the WTRU determines that the DDI is within a configured value/range, the WTRU may store the DDI. For example, the WTRU may be configured to store the DDI when the decoding status is “not successfully decoded” (i.e., NACK value of the HARQ-ACK). In another example, the WTRU may be configured to store the DDI when the accumulated mutual information is above a configured threshold. Such threshold may be determined dynamically by the WTRU using the indicated transmission parameters (e.g., MCS or number of PRBs).

In some embodiments, the WTRU may be configured to store the DDI for a downlink transmission for a HARQ process even when receiving an indication to flush the HARQ process. The WTRU may report the stored DDI to the network to help future scheduling. In an example, the WTRU may be configured to identify the DDI within its report when the WTRU already received an indication to flush the HARQ process (e.g., the WTRU received a toggled NDI for the HARQ process ID). The WTRU may indicate to the gNB the HARQ process ID and the NDI corresponding to the stored DDI after receiving an indication to flush the HARQ process.

In some embodiments, the WTRU may be configured to discard a stored DDI from its memory after receiving an indication from the network to discard a stored DDI. In another example, the WTRU may be configured to discard a stored DDI from its memory after a timer expiry. For example, the WTRU may be configured with a timer that starts or initialized when the WTRU stores a DDI. After the timer expiry, the WTRU may discard the DDI.

The DDI of a downlink transmission may include one or a combination of the following, which may also apply to a SDI and UDI): decoding status of the downlink transmission; HARQ process related information (including latest received NDI); channel measurements during the downlink transmission; transmission time of the received downlink transmission; and/or recommended transmission parameters for subsequent downlink transmissions.

In an embodiment, downlink decoding information (DDI) may include the decoding status of a downlink transmission. The WTRU may be configured to determine the decoding status of the downlink transmission. Decoding status of a transmission may refer to the outcome of decoding a transmission (i.e., whether the WTRU successful decoded or failed to decode a transmission (successfully decoding the transmission or failure to decode the transmission)). For example, after receiving a transmission, the WTRU may determine that the transmission was successfully decoded. The WTRU may then set the decoding status of the transmission to successfully decoded. The WTRU may determine the decoding status of a transmission using one or multiple repetitions/retransmissions. In an example, the WTRU may determine the decoding status of a transmission by combining multiple received repetitions of the transmission. In another example, the WTRU may determine the decoding status of a transmission by combining multiple received retransmissions of the transmission. The WTRU may be configured to store the decoding status of a transmission on its internal memory using a report.

In the following embodiments, the decoding status may be referred to as HARQ-ACK of the transmission. The HARQ-ACK may be a positive acknowledgment (ACK) or negative acknowledgment (NACK). HARQ-ACK may also refer to multi-bit HARQ feedback, where each bit of the multi-bit HARQ feedback may indicate the decoding outcome of the transmission (e.g., code block group (CBG) level feedback with each bit corresponding to CBG decoding outcome and/or code block (CB) level feedback with each bit corresponding to CB decoding outcome).

In some embodiments, the WTRU may be configured to include the decoding status of a transport block (TB) of a received downlink transmission in the DDI. The WTRU may receive a downlink transmission (e.g., single PDSCH transmission) which carries a transport block (TB). A TB may include an error detection code/mechanism that allows the WTRU to determine if the TB was successfully decoded or not. Based on the error detection code, the WTRU may include in the DDI if the TB was correctly decoded or not.

In some embodiments, the WTRU may be configured to include the decoding status of multiple TBs of a received downlink transmission in the DDI. The WTRU may be configured to receive a downlink transmission (e.g., single PDSCH transmission) which carries multiple transport blocks. Each TB may include an error detection code/mechanism to allow the WTRU to determine if a TB from the multiple TBs of the downlink transmission was successfully decoded or not. Based on the error detection code, the WTRU may include in the DDI if the TBs was correctly decoded or not.

In some embodiments, the WTRU may be configured to include the decoding status of part of a TB of a received downlink transmission in the DDI. The WTRU may be configured to receive a downlink transmission (e.g., single PDSCH transmission) which carries part of a transport block. The part of a transport block may include an error detection code/mechanism to allow the WTRU to determine if the part of TB was successfully decoded or not. Based on the error detection code, the WTRU includes in the DDI if part of the TB was correctly decoded or not. Alternatively, the part of a transport block transmitted in the downlink transmission does not include an error detection code/mechanism and the WTRU may combine the part of a transport block with other parts previously transmitted to decode the entire TB.

In some embodiments, the WTRU may be configured to include the decoding status of one or multiple code block(s) (CB(s)) of a received downlink transmission in the DDI. The WTRU may receive a downlink transmission (e.g., single PDSCH transmission) which carries a TB. A TB may comprise one or multiple CBs. Each CB may include an error detection code/mechanism that allow the WTRU to determine if the CB was successfully decoded or not. Based on the error detection code, the WTRU may include in the DDI if the CB was correctly decoded or not.

In some embodiments, the WTRU may be configured to include the decoding status of one or multiple code block group(s) (CBG(s)) of a received downlink transmission in the DDI. The WTRU may receive a downlink transmission (e.g., single PDSCH transmission) which carries a TB. A TB may comprise one or multiple CBs. One or multiple CB(s) may be grouped in a CBG. Each CBG may include an error detection code/mechanism that allows the WTRU to determine if the CBG was successfully decoded or not. Based on the error detection code, the WTRU may include in the DDI if the CBG was correctly decoded or not.

In some embodiments, the WTRU may be configured to include the decoding status of a received control information in a downlink transmission in the DDI. The WTRU may receive a downlink transmission (e.g., PDSCH) that includes a control part and a data part. In an example, the WTRU may receive a downlink transmission in a physical channel that comprises control information and data multiplexed in the physical channel. For example, some physical resource block (PRB) of the downlink channel may include the control information part, and other PRBs may include the data part. The control information part may include an error detection code/mechanism (e.g., CRC) to allow the WTRU to determine if the control information part was successfully decoded or not. In another example, the WTRU may receive a downlink transmission in a physical channel that comprises control information only (e.g., PDCCH transmission). The control information may include an error detection code (e.g., CRC) to allow the WTRU to determine if the control information was successfully decoded or not. In another example, the WTRU may receive a downlink transmission in a physical channel that includes data, and the control information is embedded within the data part (e.g., a MAC CE carrying control information part of/embedded within a TB). Using error detection mechanisms of the transport block, the WTRU may determine whether the control information was successfully decoded or not. The WTRU may store the decoding status of the control information and not the entire transport block. The decoding status of control information may then be included in the DDI.

In some embodiments, the WTRU may be configured to include/group the decoding status of multiple received downlink transmissions (e.g., multiple PDSCHs or multiple transport blocks) in a single DDI. Each downlink transmission may have TB-level decoding status and/or CB-level decoding status and/or CBG-level decoding status and/or control information-level decoding status. The decoding status of the multiple downlink transmissions may be compressed into a single decoding status (e.g., reduce the number of coded information of the decoding status). For example, the WTRU may determine the decoding status of each downlink transmission (e.g., whether it is successfully decoded or not), and if at least one downlink transmission is not successfully decoded, the WTRU may set the decoding status of the multiple received downlink transmissions to not successfully decoded. In another example, the WTRU may receive multiple downlink transmissions with some downlink transmissions that includes control information. The WTRU may then include the decoding status of only the control part(s) of downlink transmissions in a single DDI.

The WTRU may be configured to include/group the decoding status of multiple received downlink transmissions in a single DDI based on one or more of the following: single downlink control information (DCI) scheduling the multiple downlink transmissions; and/or the same transmission time of the multiple downlink transmissions. For example, the WTRU may be configured with multiple downlink transmissions in the same slot but in different carriers and/or different antennas/beams/transmission configuration indicator (TCI) state and/or different symbols.

A WTRU may report a single DDI for downlink transmissions received from multiple transmission/reception points (TRPs) as a function of the TRP-IDs (e.g., multi-DCI case).

A WTRU may be scheduled for multiple PDSCHs reception on partially or non-overlapping time/frequency resources where each PDSCH may be scheduled by a respective DCI from a different TRP, and one DDI per PDSCH. For example, the WTRU may monitor multiple DCIs on different control resource sets (CORESETs) where each CORESET may be configured with a TRP-ID (e.g., coresetPoolIndex).

In an example, the WTRU may be configured to report a single DDI as a function of the TRP-ID. For example, the DDI may be configured with a list of TRP-IDs, and the WTRU may determine to report a single DDI for all the PDSCHs scheduled on DCIs with the corresponding TRP-ID.

A single DDI may mean a DDI reporting mode which may be either a compression of multiple DDIs or an aggregation of multiple DDIs.

In one example, the WTRU may determine to compress multiple DDIs into a single DDI as a function of the multiple DDIs. For example, in the HARQ-ACK case, the WTRU may decode each PDSCH and generate one HARQ-ACK per PDSCH, and the WTRU may generate one compressed HARQ-ACK as a function of the per PDSCH HARQ-ACKs (e.g., by applying a logical ‘and’ operator on the multiple HARQ-ACKs to generate a single HARQ-ACK bit). For example, in the CSI case, the WTRU may generate one compressed CSI as a function of the per PDSCH CSI (e.g., WTRU reports one RSRP as a function of per DDI RSRP, or one set of CSI reporting quantities such as rank indicator (RI)/precoding matrix indicator (PMI)/channel quality indicator (CQI) as a function of per DDI reporting quantities).

In one example, the WTRU may determine to aggregate the DDIs together by concatenating the multiple individual DDIs into a single aggregated DDI. The aggregated DDI may be configured with a list of TRP-IDs. The WTRU may determine which TRP-IDs to include in an aggregated DDI as a function of the configured TRP-ID list. The TRP-ID list for the aggregated DDI may be, for example, radio resource control (RRC) configured, semi-statically activated (e.g., medium access control (MAC)-control element (CE)), or dynamically indicated.

A multi-panel WTRU may report a single DDI for PDSCHs received from multiple TRPs as a function of the WTRU panels.

A WTRU may be scheduled for multiple PDSCHs reception on partially or non-overlapping time/frequency resources on different WTRU antenna panels, and one DDI per PDSCH. For example, the WTRU may report a capability of multiple antenna panels/antenna port groups (e.g., a sounding reference signal (SRS) resource set) for downlink reception and may be configured with a panel/port group indicator (e.g., a SRS resource set indicator). The network may implicitly or explicitly indicate to the WTRU a panel/port group to receive a (e.g., each) PDSCH.

In an example, the WTRU may be configured to report a single DDI as a function of the panel/port group indicator. For example, the DDI may be configured with a list of panel/port group indicators, and the WTRU may determine to report a single DDI for all the downlink receptions scheduled on the associated panel/port group indicator.

In an example, the WTRU may determine the list of DDIs to report in a single DDI, and may explicitly indicate the list of panel/port group indicators in the associated single DDI.

A WTRU may report a single DDI for PDSCHs as a function of a TCI state indication.

A WTRU may be scheduled for multiple PDSCHs reception on partially or non-overlapping time/frequency resources with multiple active TCI states, and one DDI per PDSCH. For example, the WTRU may receive a DCI indicating a TCI codepoint with one or more activated TCI states, and a mapping or association of TCI states to PDSCHs.

In an example, the WTRU may be configured to report a single DDI as a function of the TCI state. For example, the WTRU may receive one or more physical channel transmissions (e.g., PDCCH, PDSCH) with the same TCI state where each physical channel may be configured with a DDI. The WTRU may then report a single DDI for all physical channels associated to the same TCI state.

In an example, the WTRU may be configured to report a single DDI as a function of the number of activated TCI states in a codepoint. For example, the WTRU may receive multiple physical channel transmissions scheduled with a single TCI codepoint which is associated to one or more activated TCI states. The WTRU may report a single DDI for all physical channels associated to both of the TCI states activated with the single TCI codepoint.

In an example, the WTRU may be configured with a set of TCI states associated to a single DDI. The WTRU may report a single DDI as a function of one or more of the DDIs associated to one or more physical channels with the same set of active TCI states.

In an example, the WTRU may receive a single DCI with a TCI codepoint associated to multiple TCI states, and a dynamic switching indication to activate one or multiple DDIs for the associated PDSCHs. For example, the DCI may indicate a dynamic switching between single and multi-TRP by activating one or multiple TCI states, and the DDI reporting behavior may be a function of the dynamic switching indication. For example, the TCI codepoint may be configured with two TCI states: TCI1 and TCI2. The DCI may include a dynamic indication to activate TCI1 (report a single DDI for TCI1), activate TCI2 (report a single DDI for TCI2), activate TCI1 and TCI2 (two reports, each report per TCI state DDI), or activate TCI1 and TCI2 (a single report with a single DDI for both TCI1 and TCI2 e.g., compressed DDI).

In an example, the WTRU may implicitly determine to report a single DDI associated to multiple TCI states as a function of the link quality of the TCI states. For example, the WTRU may monitor the link quality (e.g., RSRP, signal to noise ratio (SNR), SINR) of the source quasi co-location (QCL) RS(s) of multiple TCI states. If the WTRU determines to report multiple DDIs, the WTRU may compress them into a single DDI if the link quality associated to each of the multiple DDIs is above a threshold. The compressed single DDI may include a field where the WTRU may indicate the list of TCI states associated (compressed) to the DDI report.

In an example, the WTRU may determine to report a DDI of a subset of the multiple DDIs as a function of the associated TCI state's link quality. For example, the WTRU may report a DDI only if the link quality of the TCI state (e.g., RSRP of the QCL source RS) is above a threshold.

In an example, with multiple PDSCHs scheduled by a DCI where each PDSCH is associated with a DDI, a WTRU may determine the number of DDIs/single DDI reporting mode as a function of the TCI state associated to the PDCCH carrying the DCI. For example, if scheduled with a PDCCH transmitted on a CORESET/SS with a first TCI state, the WTRU may report one DDI per PDSCH. If scheduled with a PDCCH transmitted on a CORESET/SS with a second TCI state, the WTRU may report a single DDI (e.g., compressed or aggregated).

The WTRU may fall back to a default DDI mode of operation associated to a preconfigured TCI state (e.g., the TCI state of the PDCCH's CORESET, the TCI state of the lowest CORESET or SS ID, or the TCI state of the lowest coresetPoolIndex).

A HARQ process ID may be an identification of the HARQ process used by the gNB and/or the WTRU to identify a transmission for possibly combining multiple transmissions of the same information. The WTRU may be configured to include in the downlink decoding information the HARQ process ID of the received downlink transmission. The WTRU may receive the HARQ process indication in the scheduling DCI of the downlink transmission. Alternatively, the WTRU may determine the HARQ process using a formula (e.g., for the case of downlink semi-persistent transmission, a pre-configured formula may be used by the WTRU to determine the HARQ process ID using the slot number). In an example, the WTRU may receive a DCI scheduling a downlink transmission. The WTRU may determine the HARQ process ID, decode the received transmission, and include in the downlink decoding information the HARQ process ID and the HARQ-ACK of the received transmission.

A new data indicator (NDI) may be used to indicate to the WTRU that the data being transmitted is a new transmission and may not be combined with a previous transmission with the same HARQ process ID. The WTRU may be configured to include the NDI of the received downlink transmission in the DDI. The WTRU may receive the NDI indication in the scheduling DCI of the downlink transmission. The NDI indication may take a value of, for example, 1 or 0, to indicate to the WTRU whether or not to flush the stored information bits of the HARQ process ID. The WTRU may then determine whether to combine the received downlink transmission with a previous transmission of the same HARQ process ID. In an example, the WTRU may receive a DCI scheduling a downlink transmission. The WTRU may determine the HARQ process ID and the NDI value (e.g., NDI indicating to the WTRU to not flush the HARQ process ID), decode the received transmission, and include in the downlink decoding information the HARQ process ID, the last received NDI for the HARQ process ID and the HARQ-ACK of the received transmission.

In some embodiments, the WTRU may be configured to keep the downlink decoding information of a transmission even after receiving a DCI scheduling downlink transmission with an NDI indicating to the WTRU to flush the HARQ process ID. The WTRU may report to the gNB the DDI information of a toggled NDI. A toggled NDI may refer to the indication to flush the HARQ process ID. The WTRU may report the DDI which carries an identification to the transmission.

In some embodiments, the WTRU may be configured to report the DDI of all downlink transmissions received before the WTRU receives from the gNB a toggled NDI for a HARQ process ID. Receiving an NDI toggled for the HARQ process ID may trigger the WTRU to transmit the DDI of the downlink transmissions with the same HARQ process ID. For example, the WTRU may be configured to report the set of HARQ-ACK before the time the WTRU receives from the gNB a toggled NDI for a HARQ process ID. In another example, the WTRU may be configured to report the set of NACKs before the WTRU received a toggled NDI for a HARQ process ID (e.g., the WTRU indicates to the gNB the set of NACKs for the HARQ process ID before the NDI was toggled). Alternatively, the WTRU may be configured to report the set of ACKs before the WTRU received a toggled NDI for a HARQ process ID (e.g., the WTRU indicates to the gNB the set of ACKs for the HARQ process ID before NDI was toggled).

In some embodiments, the WTRU may be configured to indicate (e.g., as part of the downlink decoding information) the transmission time of the received downlink transmission. The transmission time indication may help the gNB identify the corresponding transmission of a received DDI. The WTRU may be configured with a reference slot and the WTRU may indicate the offset between the reference slot and the transmission time of the received downlink transmission. In an example, the WTRU may be pre-configured semi-statically with multiple possible offsets and the WTRU may select one of the pre-configured offsets. The reference slot may be fixed, semi-statically changed, or dynamically re-configured. For example, a DCI may indicate to the WTRU a reconfiguration of the reference slot. The WTRU may use the indicated reference slot to calculate or determine the offset for a received downlink transmission. In some embodiments, the WTRU may be configured with multiple reference slot(s), and each reference slot may correspond to one or more of the following: a transmission type, where each transmission type may have a different reference slot; a transmission priority, where each transmission priority may have a different reference slot; a QCL configuration, where each QCL configuration may have a different reference slot; a TCI state, where each TCI state may have a different reference slot; a bandwidth part (BWP), where each BWP may have different reference slot, or a carrier component (CC), where each CC may have a different reference slot.

In some embodiments, the WTRU may be configured to indicate (e.g., as part of the downlink decoding information) the transmission time of the received downlink transmission. The WTRU may indicate to the gNB the frame number and the slot number within the frame.

A WTRU may perform measurements and may include the measurements in the DDI to be reported to the gNB. The WTRU may perform the measurements on the received downlink transmission. For example, the WTRU may perform the measurements on reference signals within the channel carrying the downlink transmission (e.g., DMRS of the PDSCH carrying the downlink transmission). The WTRU may be configured to perform the measurement on a reference signal(s) that are not part of the channel carrying the downlink transmission but have some commonality with the channel carrying the downlink transmission. The commonality between the reference signal and the channel may be one or more of the following: a same TCI; a same bandwidth part (BWP); a same component carrier (CC); and/or a same QCL configuration.

In an example, a downlink decoding information (DDI) may include a measurement of the channel during the reception of the downlink transmission. The WTRU may be configured to measure the channel during the reception of the transmission using the downlink demodulation reference signals (DMRS) and/or channel state information reference signals (CSI-RS) that is configured in proximity of the physical resources of the downlink transmission. For example, the WTRU may use CSI-RS measurement if the CSI-RS frequency resource is configured with a preconfigured frequency offset from the RB allocation of the downlink transmission and/or CSI-RS time resource is within a preconfigured slot/symbol offset from the transmission time of the downlink transmission. The WTRU may then determine the channel state by determining, for example, the CQI and/or SINR and/or received signal strength indicator (RSSI) and/or RSRP and/or reference signal received quality (RSRQ) during the transmission. The WTRU may use the determined channel state as downlink decoding information.

The WTRU may be configured to determine the SINR based on RSRP and/or RSRQ and/or RSSI measurements. For example, the WTRU may be configured to calculate or determine the SINR with the following formula: SNIR=RSRP-RSSI (in dB), where the RSRP is the power of the received reference signal and the RSSI is the total received power.

In an example, downlink decoding information (DDI) may include the channel state prediction for a future transmission based on the reception of the downlink transmission. The WTRU may be configured to measure the channel during the reception of the transmission using the downlink demodulation reference signals (DMRS) and/or channel state information reference signals (CSI-RS) that is configured in proximity of the physical resources of the downlink transmission. The WTRU may then estimate the channel state for next N slot(s) (e.g., the WTRU estimates the CQI and/or SINR and/or RSSI and/or RSRP and/or RSRQ for the next N slots).

In an embodiment, the downlink control information may include a best predicted beam. For example, the WTRU may determine a best spatially predicted beam and/or best temporally predicted beam applicable in the future (e.g., applicable after N msec, slots and/or frames in the future where N may be preconfigured/indicated by the network via RRC/MAC-CE and/or DCI). In an example, the WTRU may perform measurements on RSs (e.g., DMRS, CSI-RS, and/or synchronization signal blocks (SSBs)) associated with a downlink transmission (e.g., RSs QCL-TypeD related with the latest transmission of PDCCH/PDSCH). Based on the measurements, the WTRU may determine measured beam qualities (e.g., RSRP, noise power) of measured RSs associated with the downlink transmission. Based on the measurements, the WTRU may determine one or more of the following. The WTRU may determine a predicted best (e.g., beams with highest RSRP) beams. The WTRU may perform one or more temporal and/or spatial predictions of beam indices of Top-K (best K beams/strongest K beams) (e.g., K=1, for example, K preconfigured/indicated by the network via RRC/MAC-CE and/or DCI) highest quality beams. The WTRU may determine predicted qualities (e.g., RSRPs, SINR). The WTRU may perform one or more (e.g., Top-K) temporal and/or spatial predictions of RSRPs of beams.

In some embodiments, downlink decoding information (DDI) may include the accumulated mutual information for the downlink transmission (e.g., TB transmission). The WTRU may be configured to sum the mutual information for each transmission corresponding to the TB (retransmissions) to obtain the accumulated mutual information. The WTRU may be configured to calculate or determine the mutual information using channel measurements (e.g., SINR) and the configured MCS and number of allocated resource elements (REs) (e.g., to determine the rate of the transmission). The WTRU may then use the calculated accumulated information as downlink decoding information.

In an example, the WTRU may be configured to include in the DDI a recommended MCS. The WTRU may be configured with a list of MCS and select an MCS to be recommended in the DDI. The WTRU may determine the recommend MCS based on the measurement performed during the transmission. The WTRU may be configured to determine the recommended MCS based on the QoS requirements and the measurements during the transmission. The QoS requirements may include a block error rate (BLER) target and latency requirement.

In an example, the WTRU may be configured to include in the DDI a recommended resource block (RB) allocation. The WTRU may be configured with a list of RB allocation and select an RB allocation to be recommended in the DDI. The WTRU may determine the recommend RB allocation based on the measurement performed during the transmission. The WTRU may be configured to determine the recommended RB allocation based on the QoS requirements and the measurements during the transmission. The QoS requirements may include a BLER target and latency requirement.

In some embodiments, the WTRU may be configured to determine when to report, or conditions for reporting, a DDI for a received downlink transmission or to report a DDI of a part of a received downlink transmission. The WTRU may be configured to report the DDI for a received downlink transmission or part of the received downlink transmission when one or more of the following occurs or based on one or more of the following conditions or events.

The WTRU may be configured to report the DDI for a received downlink transmission or part of the received downlink transmission if the WTRU received an indication from a network entity (e.g., the gNB) requesting the report of the DDI. For example, the WTRU may receive the indication in the DCI scheduling the downlink transmission.

The WTRU may be configured to report the DDI for a received downlink transmission or part of the received downlink transmission based on a decoding outcome. For example, the WTRU may be configured to report the DDI of the received downlink transmission and/or part of received downlink transmission when the decoding outcome is an ACK (i.e., successful decoding). In another example, the WTRU may be configured to report the DDI of the received downlink transmission when the decoding outcome is a NACK (i.e., not successful decoding).

The WTRU may be configured to report the DDI for a received downlink transmission or part of the received downlink transmission based on a measurement (e.g. a measured SINR/CQI/RSRP/RSSI) of the downlink transmission, or a portion of the downlink transmission. For example, the WTRU may be configured to report the DDI for a received downlink transmission or part of the received downlink transmission if a measurement (e.g. a measured SINR/CQI/RSRP/RSSI) of the downlink transmission, or a portion of the downlink transmission, is above a configured threshold. For example, the WTRU may be configured to measure a PDSCH DMRS and if at least one measurement results (e.g., SINR/CQI/RSRP/RSSI) is above a configured threshold, the WTRU may report the DDI.

The WTRU may be configured to report the DDI for a received downlink transmission or part of the received downlink transmission based on a measurement (e.g., a measured SINR/CQI/RSRP/RSSI) of another downlink transmission (e.g., CSI-RS). For example, the WTRU may be configured to measure a CSI-RS that may be near in time and/or frequency of the received downlink transmission. If at least one measurement result (e.g., SINR/CQI/RSRP/RSSI) is above a configured threshold, the WTRU may report the DDI.

The WTRU may be configured to report the DDI for a received downlink transmission or part of the received downlink transmission based on whether the downlink transmission/part of the downlink transmission is control information or includes control information. For example, the WTRU may be configured to report the DDI for a received downlink transmission or part of the received downlink transmission if the downlink transmission/part of the downlink transmission is a control information (i.e., if the downlink transmission is a control information). For example, the WTRU may receive a downlink transmission which includes control information and data information. The WTRU may then report the DDI of the downlink transmission/part of the downlink transmission.

The WTRU may be configured to report the DDI for a received downlink transmission or part of the received downlink transmission based on a priority associated with the received downlink transmission/part of the downlink transmission. For example, the WTRU may be configured to report the DDI for a received downlink transmission or part of the received downlink transmission if a priority associated with the received downlink transmission/part of the downlink transmission is above a configured threshold. For example, the WTRU may receive a downlink transmission which includes high priority data (e.g. higher than a configured threshold). The WTRU may then report the DDI of the downlink transmission/part of the downlink transmission. The WTRU may be configured to determine the priority of the received downlink transmission/part of the downlink transmission from the control information scheduling the transmission (e.g., a priority bitfield in the DCI scheduling the transmission). In another example, the WTRU may be configured to determine the priority of the received downlink transmission/part of the downlink transmission based on a channel structure of the transmission. For example, a transmission with a smaller number of symbols (e.g., below a pre-configured number of symbols) may be reserved for high priority transmission. In another example, a transmission with a smaller number of PRBs (e.g., below a pre-configured number of PRBs) may be reserved for high priority transmission. The WTRU may be configured with priorities for which the DDI should be reported, for example, a list of priorities for which the DDI should be reported.

The WTRU may be configured to report the DDI for a received downlink transmission or part of the received downlink transmission based on a number of retransmissions of the downlink transmission or part of the downlink transmission. For example, the WTRU may be configured to report the DDI for a received downlink transmission or part of the received downlink transmission if the number of retransmissions of the downlink transmission/part of the downlink transmission is below a configured threshold (i.e., how many times the same transmission is retransmitted). For example, when the WTRU receives an initial transmission, the number of retransmissions may be equal to or may be set to, for example, 0. In another example, when the WTRU receives a first retransmission transmission, the number of retransmissions is equal to or may be set to, for example, 1. Each part of the downlink transmission may have a different number of retransmissions (e.g., the gNB may multiplex a retransmission with a new transmission). The WTRU may be configured with number of retransmissions parameter for which the DDI should be reported. For example, the WTRU may be configured with a maximum number of retransmissions parameter for which the DDI may be reported (e.g. if the number of retransmissions is above the maximum number, the WTRU does not report the DDI).

The WTRU may be configured to report the DDI for a received downlink transmission or part of the received downlink transmission based on a number of retransmissions of the downlink transmission/part of the downlink transmission. For example, if the number of retransmissions of the downlink transmission/part of the downlink transmission is above a configured threshold, the WTRU may report the DDI.

The WTRU may be configured to report the DDI for a received downlink transmission or part of the received downlink transmission based on channel conditions during the downlink transmission. For example, the WTRU may be configured to report the DDI only when the measured channel conditions during the downlink transmission is above a configured threshold (i.e., in good channel conditions the WTRU may report the DDI). In an example, the WTRU may be configured to report the DDI only when the measured channel conditions during the downlink transmission is below a configured threshold (i.e., in bad channel conditions the WTRU may report the DDI). The WTRU may determine the channel conditions during the downlink transmission using the measurements of configured reference signals.

The WTRU may be configured to report the DDI for a received downlink transmission or part of the received downlink transmission based on a DDI value, for example, whether a DDI value is in a configured value/range. When the WTRU determines that the DDI is within the configured value/range, the WTRU may report the DDI. For example, the WTRU may be configured to report the DDI when the decoding status/outcome is “not successfully decoded” (i.e., NACK value of the HARQ-ACK). In another example, the WTRU may be configured to report the DDI when the accumulated mutual information is above a configured threshold. Such threshold may be determined dynamically by the WTRU using indicated transmission parameters (e.g., MCS or number of PRBs).

The WTRU may be configured to report the DDI for a received downlink transmission or part of the received downlink transmission based on based on (e.g. after) a configured time from the scheduling time of the downlink transmission/part of the downlink transmission. For example, if a time from the scheduling time of the downlink transmission/part of the downlink transmission if after/later/greater than a configured time value, the WTRU may report the DDI.

In some embodiments, the WTRU may determine an importance or when to report to a DDI according to one or more of the following in a TB, CB and/or CBG. The importance of a DDI may indicate to the WTRU whether the WTRU needs to report the DDI to the gNB or not.

The WTRU may determine an importance based on a latency budget. For example, the WTRU may determine a high importance for a DDI when the latency associated with a received data transmission is below a threshold. In an example, such a latency budget may be indicated for a PDU of a PDU set (i.e. PDU Set Delay Budget (PSDB) for a QoS flow associated with XR traffic).

The WTRU may determine an importance based on a priority of the received data. For example, the WTRU may be indicated with, or receive information regarding, a priority in the control information associated with a received data transmission. The WTRU may determine an importance for a DDI according to the indicated priority. The indicated priority may be, in one example, a quantized numerical value (e.g. in a (pre)configured range).

The WTRU may determine an importance based on a decoding error rate. For example, the WTRU may determine a high importance for a DDI when the (pre)configured decoding error rate of a received TB, CB and/or CBG, (e.g. a PDU error rate, PDU Set Error Rate (PSER), frame error rate) is below a threshold value.

The WTRU may determine an importance based on an application associated with the received data. In an example, the WTRU may determine a high importance for a received data transmission including a system information block (SIB), random access channel (RACH) messages (Msg2/Msg4), handover messages, and/or XR traffic.

The WTRU may determine an importance based on a number of decoding errors. For example, the WTRU may include a multitude of decoding errors (e.g., corresponding to a sub-set of received CBs and/or CBGs in a DDI). The WTRU may determine a high importance when the number of included decoding errors exceed a threshold value.

The WTRU may determine an importance based on decoding parameters. For example, the WTRU may determine one or more following of the decoding parameters associated with a decoding error: estimated SINR of the DMRS of the control and/or data channel, and/or a number of channel coding iterations (e.g., LDPC decoding iterations). The WTRU may determine a high importance for the DDI when the estimated SINR is above or below a SINR threshold. In an example, the WTRU may determine a high importance for the DDI when the number of decoding iterations is above or below a threshold.

The WTRU may determine an importance based on an importance indication of the received TB, CB and/or CBG. For example, the WTRU may determine a high importance for a DDI when the importance of the PDU carried in the received TB, CB and/or CBG (e.g. PDU Set Importance PSI) is below or above a threshold.

The WTRU may determine an importance based on a type of the data with a decoding error. For example, the WTRU may determine a high importance for a DDI when the decoding error occurs to the multiplexed control information.

The WTRU may determine an importance based on HARQ enabled/disabled. For example, the WTRU may determine a high importance for a DDI when the DDI occurs to a TB, CB and/or CBG with HARQ enabled. For example, the WTRU may determine a low importance for a DDI when the DDI occurs to a TB, CB and/or CBG with HARQ disabled.

The WTRU may determine an importance based on the memory for storing the DDI. For example, the WTRU may determine a high importance for a DDI when the memory storage of the DDI exceeds a threshold value. In an example, the memory storage may include the buffer memory to store DDI and soft buffer memory of the HARQ associated with the received TB, CB and/or CBG.

The WTRU may determine an importance based on a time duration of the DDI. For example, the WTRU may determine a high importance for a DDI when the time duration of the DDI stored in memory exceeds a threshold value. In an example, the WTRU may dynamically increase the importance in proportion to the time of the DDI stored in the memory.

In an example, the importance of the DDI may be a range of numerical values that may increase or decrease with increased level of importance. In an example, the importance of the DDI may be a binary indication. In some embodiments, a WTRU may maintain, store and/or report multiple sets of DDIs with each set including DDIs with identical importance value. In an example, a WTRU may prioritize to report the set of DDIs with the highest importance. As discussed herein, the importance of a DDI may be used interchangeable with a priority of the DDI.

In an embodiment, the WTRU may be configured to determine the priority for a DDI based on at least one of the following.

The WTRU may be configured to determine the priority for a DDI based on a downlink transmission type. In an example, the WTRU may be configured to determine the DDI priority based on the downlink transmission type of the DDI. For example, the WTRU may be configured to determine the DDI priority based on whether the decoded data is user data (e.g., PDSCH), control information (e.g., PDCCH), broadcast information (e.g., PBCH) or a reference signal (e.g., CSI-RS). For example, the WTRU may be configured to determine the DDI priority based on whether the decoded data is a dedicated transmission or a shared or common transmission. For example, the WTRU may be configured to determine the DDI priority based on a casting type of the transmission, such as if the casting type is broadcast, unicast or multicast/groupcast. For example, the WTRU may be configured to determine the DDI priority based on the MCS (e.g., indicated to the WTRU based on an MCS index). The WTRU may be configured to determine one priority if the associated transmission has a first MCS index and another priority otherwise. For example, the WTRU may be configured to determine the DDI priority based on the QoS requirements (e.g., associated with QoS identifier (such as 5 QI), QoS priority, QoS resource type, and/or packed delay budget). The WTRU may determine one priority for real time traffic data (e.g., URLLC, QoS identifier=2) or another priority for streaming media (e.g., video streaming, QoS identifier=9). In an example, the WTRU may receive an indication (e.g., DCI) with the priority associated with at least one of the above indicated transmission types and the WTRU may be configured to determine the DDI priority based on the indicated priority.

The WTRU may be configured to determine the priority for a DDI based on a TCI-State associated with the downlink transmission. In an example, the WTRU may be configured with at least one TCI state (e.g., TCI-state ID) for at least one downlink resource, where the TCI-State ID may comprise priority information (e.g., downlink transmission priority or DDI priority). The WTRU may be configured to determine the DDI priority based on the associated priority information indicated in the TCI state of the corresponding downlink transmission. In an example, the WTRU may be configured with QCL information (e.g., QCL type) of a first downlink resource with at least one second downlink resource. The WTRU may be configured to determine the DDI priority of the first downlink resource based on the indicated priority (e.g., downlink transmission priority or DDI priority) based on at least one second downlink resource. In an example, the WTRU may be configured with rules for determining the DDI priority where the rules may comprise at least one of the above-mentioned factors. In an example, the WTRU may be configured to report the factors based on which the WTRU determined the DDI priority. In an example, the WTRU may be configured to determine the DDI priority as a numerical value (e.g., binary value, N-ary value, percentage (e.g., between 0 and 100), continuous value (e.g., between 0 and 1)). In an example, the WTRU may be configured to determine the DDI priority as a categorical value (e.g., high, low, or medium). The WTRU may be configured to report the determined DDI priority.

In some embodiments, when the WTRU determines to not report a DDI, the WTRU may be configured to combine it with another DDI at a later occasion.

In some embodiments, the WTRU may be configured to report multiple DDIs in or with a single report to the gNB. The report may include information regarding the channel(s)/transmission(s) from the gNB to the WTRU (possible a DDI described above). For example, a DDI of a first downlink transmission and DDI of a second downlink transmission may be grouped in the same group. In an example, HARQ-ACK feedback of multiple PDSCHs may be included in the same report (e.g., 1-bit ACK/NACK of a first transmission and 1-bit ACK/NACK of a second transmission may be included in a report resulting in the report to have a size of 2 bits). In an example, a multi-bit HARQ-ACK feedback of the same PDSCH may be included in the same report with a single bit HARQ-ACK feedback of another PDSCH transmission. In an example, a recommended MCS of multiple PDSCHs transmissions may be aggregated in the same report.

The report may be transmitted to the gNB using an uplink resource. The report may be transmitted using a physical layer channel and/or higher layer message. For example, the report may be transmitted to the gNB using a physical uplink control channel (PUCCH) or physical uplink shared channel (PUSCH) transmission. In an example, the report may be transmitted to the gNB using a MAC CE and/or RRC signaling.

The WTRU may be configured with report parameters that set different aspects of the report. For each report, the WTRU may be configured with one or more of the following parameters for the report.

The WTRU may be configured with a report identification (ID). The report ID parameter may differentiate between multiple reports that the WTRU may support. The report ID may be used by the gNB and/or the WTRU to identify the transmission/reception of a report. The report ID may take values from a pre-defined range. In some embodiments, a report ID may depend on other report parameters. For example, for some channel type, the report IDs range may be restricted to a subset of the possible report ID ranges (e.g., control channel type may have profile ID from 0 to 2).

The WTRU may be configured with a channel type for which the decoding information is being reported. The channel type parameter may be used to separate information of different channel types. For example, information related to a control channel may be included in a report with a channel type parameter equal to control channel. Information related to a data channel may be included in a report with a channel type parameter equal to data channel. The possible channel type parameter values may be, for example, unicast control channel; broadcast control channel; unicast data channel; broadcast data channel; unicast control and data channel; and/or broadcast control and data channel.

The WTRU may be configured with a report priority. The report priority parameters may indicate to the WTRU the priority of report. The report priority may be used by the WTRU to prioritize transmission/reporting between multiple reports. The WTRU may also use the report priority to determine the physical channel to transmit the report. For example, some physical channel may be configured for high priority transmissions. The WTRU may select those channels to transmit a high priority report.

The WTRU may be configured with a report size. The report size parameter may indicate to the WTRU the size of the report and may avoid any mismatch between the WTRU and gNB. For example, a report size equal to N bits may require the WTRU to send the report with N bits. In some embodiments, the WTRU does not send the report until the size of the report is reached (i.e., collecting information until the size of collected information is equal to the size of the report). In an example, the WTRU may use padding to reach the report size when the collected information is smaller than the configured size.

The WTRU may be configured with a maximum validity time of the report. The maximum validity time parameter may indicate to the WTRU a time difference between the time an information is stored/included in the report and the time the report should be reported. For example, a maximum validity time equal to 10 ms may mean or indicate that once the WTRU stored a first information in the report, the WTRU should send the report at most 10 ms later. If the WTRU starts storing information in the report at time t, the WTRU should send the report at most at t+TMax validity time where TMax validity time equals to the maximum validity time of the report. The WTRU may flush the report after the maximum validity time has expires or passes. If the WTRU determines that a subsequent information should be stored in that report, the WTRU may store that information and should transmit the report before the maximum validity time. In an example, the WTRU may be configured to start a timer when it starts storing information in the report with value equals to the maximum validity time. The WTRU may send the report prior to the timer expiry, or otherwise, the WTRU may flush the report. The WTRU may be configured to use a timer (e.g., referred to as validity time) whenever it starts collecting information in the report.

The WTRU may be configured with a type of downlink decoding information to be included in the report. For example, whether HARQ-ACK feedback should be included, and whether single bit or multi-bit HARQ-ACK feedback should be included.

The WTRU may be configured with an encoding scheme. The encoding scheme parameter may indicate to the WTRU which encoding scheme to apply to the report. For example, whether a Low Density Parity Check (LDPC) or polar encoding may be used for the report.

The WTRU may be configured with carrier(s) on which the report can be transmitted. For example, the WTRU may only transmit the report on one of the carriers configured for the report.

The WTRU may be configured with BWP(s) on which the report can be transmitted. For example, the WTRU may only transmit the report on one of the BWPs configured for the report.

The WTRU may be configured with a set of HARQ process IDs. For example, the WTRU may be configured with a list or set of HARQ process IDs for a report. The WTRU may include the DDIs of the downlink transmission with the HARQ process ID that is part of the set of HARQ process IDs.

The report parameter configuration may be dynamic (e.g., using a DCI) and/or semi-statically (e.g., using RRC/higher layer signaling).

In some embodiments, the WTRU may be configured to associate a DDI of a received downlink transmission or part of downlink transmission with a report which includes multiple DDIs based on one or more of the following.

The WTRU may be configured to associate a DDI of a received downlink transmission or part of downlink transmission with a report which includes multiple DDIs based on characteristics of the downlink transmission. The characteristics of the downlink transmission may include the transmission type of the corresponding transmissions (e.g., whether the transmission is control or data transmission).

The WTRU may be configured to associate a DDI of a received downlink transmission or part of downlink transmission with a report which includes multiple DDIs based on the HARQ process ID associated with the downlink transmission. For example, the WTRU may be configured with a list of HARQ process IDs that may be carried in a report.

The WTRU may be configured to associate a DDI of a received downlink transmission or part of downlink transmission with a report which includes multiple DDIs based on the report priority and the priority of the downlink transmission of the DDI. For example, the WTRU may be configured with a mapping or association between the priorities of the downlink transmission and the report priorities.

The WTRU may be configured to associate a DDI of a received downlink transmission or part of downlink transmission with a report which includes multiple DDIs based on remaining bits available for the report. The WTRU may be configured to associate a DDI with a report based on the remaining bits for the report (e.g. the report may already include other DDIs for other transmissions) and the size of the DDI.

The WTRU may be configured to associate a DDI of a received downlink transmission or part of downlink transmission with a report which includes multiple DDIs based on the maximum validity time of the report. The WTRU may associate a DDI with a report if the report validity time did not expire (e.g. the report validity time is below the maximum validity time of the report)

In some embodiments, the WTRU may be configured with multiple reports (i.e., have multiple reports configured at the same time). For each report, the WTRU may be configured with different parameters. For example, the WTRU may be configured with a first report with a first set of parameters and a second report with a second set of parameters. The first report may be configured with a channel type value set to unicast control channel and the second report may be configured with channel type value set unicast data channel. The WTRU may report HARQ-ACK feedback of the data channel in the second report while reporting the decoding status of multiple control channels in the first report.

The WTRU may be configured to prioritize among multiple reports. The WTRU may use the priority of the feedback to determine which report to prioritize. A prioritization procedure may comprise determining which report(s) to transmit, which report(s) to delay, and which report(s) to drop. If the WTRU drops a report, the WTRU may flush the report and may use it at later occasion for other information.

In some embodiments, the WTRU may be configured with one or more triggers to transmit one or multiple reports. Each report may carry multiple DDIs. The WTRU may be configured to transmit one or multiple reports based on one or more of the following.

The WTRU may be configured to transmit one or multiple reports based on the report priority. For example, if the priority of the report is high (e.g. above a threshold value, the WTRU may trigger the transmission of/send the report.

The WTRU may be configured to transmit one or multiple reports based on the report size reached the configured size of the report. For example, the WTRU may trigger the report transmission when the information included in the report reaches the configured size of the report.

The WTRU may be configured to transmit one or multiple reports based on a maximum validity time of the report. For example, the WTRU may trigger the report when the validity time of the report expires or before expiring.

The WTRU may be configured to transmit one or multiple reports based on a request from the network to transmit the report.

The WTRU may be configured to transmit one or multiple reports based on the WTRU receiving a DCI scheduling a downlink transmission with a toggled NDI for a HARQ process ID for which the DDI is included in the report.

In an embodiment, the WTRU may be configured with multiple reports. Each report may carry or include multiple DDI and the report may be configured with one or more of the following parameters: report ID; channel type for the report (e.g., report for control/data); report priority; report size; and/or a maximum validity time of the report. The WTRU may be configured to receive a downlink transmission that includes one or multiple parts. The multiple parts may carry or include data and/or physical control information (e.g., the downlink transmission includes a downlink control information multiplexed with a TB, and the TB comprises multiple CBs and/or CBGs). The WTRU may receive the downlink transmission in a physical downlink channel and may start decoding the transmission. The WTRU may determine downlink decoding information (DDI) for each part of the multiple parts of the downlink transmission. The DDI may include at least decoding status of the part downlink transmission. The WTRU may determine whether or not to report the DDI for a part of the received downlink transmission based on one or more of the following: the part of the downlink transmission is a control information; the priority of the part of the downlink transmission; the number of retransmissions of the part of the downlink transmission; and/or channel conditions during the transmission. The WTRU may associate a DDI with a report comprising at least report priority, remaining available bits on the report, and the maximum validity time of the report based on the characteristics of the downlink transmission (e.g., transmission type and/or HARQ process ID corresponding to the transmission). The WTRU may trigger the transmission of (e.g. determine to report) one or more reports based on one or more of: the report priority; the report information reached the feedback size; the maximum validity time of the report; and/or a request from the network to transmit the report. The WTRU may request an uplink resource from the gNB to transmit the triggered report (e.g., PUCCH transmission). The WTRU may determine the required size based on the number and the size of each triggered report. The WTRU may request an uplink grant and indicate the required size using a PUCCH resource (e.g., indication to the gNB using the PUCCH sequence). The WTRU may receive an indication of an uplink resource(s) and may transmit one or more reports in the uplink resource(s) (e.g., using a MAC CE to transmit the feedback).

A WTRU may determine to send or transmit a DDI report based on one or more conditions, events, or triggers. For example, the WTRU may determine, be configured, and/or indicated to trigger one or more DDI reporting events. In an example, the conditions, events, and/or triggers may be based on received indications and/or configurations (e.g., from a gNB), a decoding outcome, a measured SINR, a received downlink priority, a number of retransmissions, as described herein. For example, the WTRU may send the report to a gNB. In an example, the WTRU may send the report and/or indications via for example, a UCI, a MAC-CE, and/or RRC signaling.

Hereafter, for the brevity of discussion, the reporting may comprise the DDI reporting, however the embodiments and examples in the disclosure may equally (or equivalently or extendedly.) be employed (e.g., applicable) for cases with reporting other indications, quality parameters, and/or values.

In an example handshake procedure, a WTRU may send one or more indications (e.g., to a gNB), indicating that a DDI reporting event is triggered at or by the WTRU. That is, the WTRU may indicate that the WTRU wants to report the DDI. In an example, the WTRU may send the indication as part of the HARQ-ACK (e.g., enhanced) codebook, for example via a flag indication. For example, a first value may indicate that a DDI report may be required and/or available (i.e., the WTRU wants to send the report or that the report will be sent) and a second value may indicate that no DDI report may be required and/or available. (i.e., the WTRU does not want to send the report or no report will be sent). In an example, the WTRU may send a special scheduling request (SR) to indicate that DDI reporting may be required (e.g., to request uplink resources for reporting the DDI). In an example, the WTRU may indicate the required DDI reporting via a MAC-CE indication.

After transmission of the indication, the WTRU may receive one of more configuration information and/or indications regarding one or more uplink grants and/or resources for reporting the DDI report. For example, the WTRU may receive the indications and/or configurations, for example from a gNB, for example via RRC, a MAC-CE, or a DCI.

In an instantaneous reporting scenario embodiment, a WTRU may determine, be configured, and/or indicated to report the DDI via instantaneous reporting based on one of more conditions. For example, the WTRU may report the DDI as part of one or more UCI occasions, for example as soon as a DDI reporting event may be triggered. The WTRU may receive one or more configuration information and/or indications on instantaneous reporting, for example via a DCI, a MAC-CE, or RRC signaling, for example including one or more threshold values.

For example, the WTRU may use one or more (pre)configured UCI resources in one or more uplink resources for instantaneous DDI reporting. In an example, the WTRU may use one or more UCI resources configured in one or more PUCCH and/or PUSCH occasions for instantaneous reporting. That is, the WTRU may skip and/or drop the (pre)configured CSI and/or HARQ-ACK reporting that was supposed to be reported in the corresponding UCI resources and the WTRU may report the DDI instead. The WTRU may indicate that the reported UCI includes the DDI, for example via an indication (e.g. flag indication). In an example, the flag indication may include a first value to indicate that the UCI includes the configured information (e.g., CSI, and/or HARQ-ACK). In another example, the indicated flag indication may include a second value to indicate that the UCI includes the DDI reporting.

In an example, the WTRU may report a compressed version of a DDI in instantaneous reporting. That is, the WTRU may determine the parameters to be reported in the instantaneous DDI reporting based on the size of the configured UCI resources. For example, the WTRU may determine to report only parts of the DDI in instantaneous reporting, if the size of the UCI is smaller than the size of the DDI.

The WTRU may determine to use the instantaneous DDI reporting based on one or more conditions and/or events. For example, the WTRU may determine to use the instantaneous DDI reporting based on a priority. For example, the WTRY may determine, be configured, and/or indicated to use instantaneous reporting if the priority of the received downlink transmission is higher than a determined, configured, and/or indicated threshold value. That is, the WTRU may use the instantaneous DDI reporting for prioritized received downlink transmissions. In another example, the WTRU may determine to use the instantaneous DDI reporting based on latency. For example, the WTRU may determine, be configured, and/or indicated to use instantaneous reporting if a time for the handshake procedure, as described herein, for DDI reporting is longer than a determined, (pre)configured, and/or indicated time threshold. That is, the WTRU may use one or more uplink resources that are closer in time for the instantaneous reporting.

In some embodiments, the WTRU may receive an uplink configuration information, for example indicating uplink resource(s), along with an indication to transmit a DDI report. The uplink resource(s) may be a PUCCH resource or PUSCH resource. The PUSCH resource may be a configured grant or a dynamic grant. The WTRU may then use the configured resource to transmit one or multiple reports carrying DDI information.

In some embodiments, the WTRU may be configured to select one or more uplink resources, among multiple available uplink resources, to transmit a DDI report. The WTRU may be configured with multiple uplink resources (e.g., multiple PUCCH and/or PUSCH resources) and the WTRU may select one (e.g. at least one) of the resources to transmit the DDI report. The WTRU may be configured to select an uplink resource based on one or more of the following conditions

The WTRU may be configured to select an uplink resource based on a validity time/maximum validity time of the report and the uplink resource transmission time. For example, the WTRU may select an uplink resource with a transmission time within the maximum validity time of the DDI report.

The WTRU may be configured to select an uplink resource based on a priority of the uplink resource transmission time. For example, the WTRU may select an uplink resource with a configured priority higher or equal to the priority of the DDI report.

In some embodiments, the WTRU may be configured to request an uplink resource to transmit one or multiple DDI reports. The uplink resource may be a PUCCH resource or PUSCH resource. In an example, the WTRU may be configured to request a PUSCH resource to transmit a DDI report using a PUCCH resource. For example, the WTRU may be configured with a periodic PUCCH resource that may indicate to the gNB the request of a PUSCH resource. Such PUCCH resource may indicate to the gNB one of the report parameters (e.g., report priority). In an example, the WTRU may be configured to use a buffer status report (BSR) to request an uplink resource to transmit the DDI report.

In some embodiments, the WTRU may be configured to transmit a DDI report using a MAC CE. The WTRU may use a received grant (e.g. grant of an uplink resource) and transmit the DDI report using a MAC CE within the received uplink resource indicated by the grant. In an embodiment, the WTRU may be configured to transmit the DDI report using uplink control information (UCI). In an embodiment, the WTRU may be configured to transmit part of the DDI report using UCI and another part using a MAC CE.

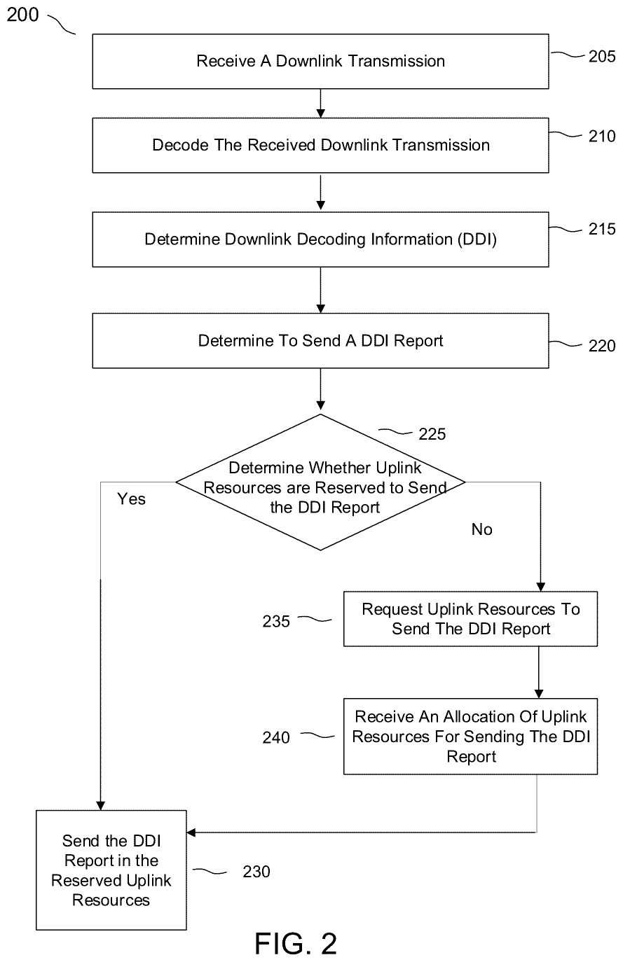

FIG. 2 shows an example procedure 200 for downlink decoding information (DDI) reporting. A WTRU may receive a downlink transmission 205. The downlink transmission may be received from a network node (e.g., a gNB). The downlink transmission may be a scheduled downlink transmission, where the WTRU may receive a downlink control information (DCI) that schedules the downlink transmission and the WTRU receives the scheduled downlink transmission in resources based on the DCI. The WTRU may receive the DCI from the gNB.

The WTRU may decode 210 the received downlink transmission. The WTRU may determine downlink decoding information (DDI) 215. The DDI may include one or more of the following: a HARQ-ACK of the received downlink transmission (i.e., ACK or NACK); a HARQ process identification (ID); a new data indicator (NDI) of the received downlink transmission; a transmission time of the received downlink transmission (e.g., an offset from a reference slot); and/or at least one measurement. The at least one measurement may comprise, for example, one or more of: a channel quality indicator (CQI), signal to interference plus noise ratio (SINR), reference signal received power (RSRP) of the downlink transmission or a portion of the downlink transmission (e.g., PDSCH demodulation reference signal (DMRS)) or another downlink transmission (e.g., a channel state information (CSI)-reference signal (RS) that may be near in time and/or frequency of the downlink transmission).

The WTRU may determine to report the DDI 220 (e.g. send a DDI report) to the gNB. The WTRU may determine to report the DDI based one or more conditions or events. The WTRU may determine to report the DDI based on whether the WTRU receives an indication from the gNB requesting a DDI report. The indication requesting a DDI report may be received in the DCI scheduling the downlink the transmission or another DCI). The WTRU may determine to report the DDI based a decoding outcome (e.g., HARQ ACK or HARQ NACK) of the downlink transmission. The WTRU may determine to report the DDI based on whether a measurement (e.g., a measured SINR) during the downlink transmission is above a configured threshold value. The WTRU may determine to report the DDI based on whether a number of retransmissions for or associated with the HARQ process ID is below a configured threshold. The WTRU may determine to report the DDI based on whether a priority associated with the received downlink transmission is above threshold.

The WTRU may determine whether uplink resources are reserved, allocated, or configured to send the DDI report 225. For example the gNB may provide an uplink resource for the DDI report in a DCI (e.g. in the DCI that that schedules the downlink transmission or another DCI, or RRC signaling).

If uplink resources are reserved, allocated, or configured for sending the DDI report, the WTRU may send the DDI report in the reserved, allocated, or configured uplink resources 230.

If uplink resources are not reserved, allocated, or configured for sending the DDI report, the WTRU may request an uplink resource or resources to send the DDI report 235 (e.g., send a message to the gNB indicating a request for uplink resources for sending the DDI report). The WTRU may receive a message 240 (e.g. DCI) that schedules or allocates one or more uplink resources for sending the DDI report. The WTRU may send the DDI report 230 in the allocated uplink resources for the DDI report.

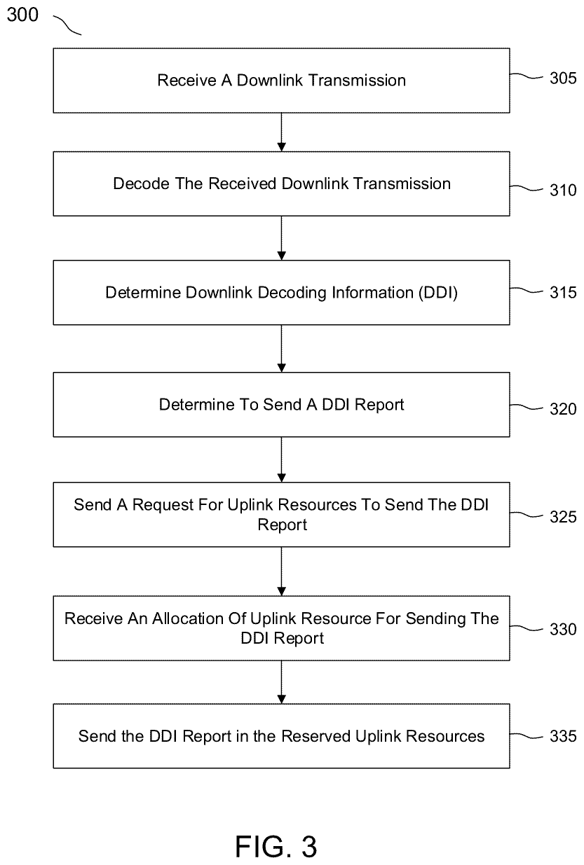

FIG. 3 shows an example procedure 300 for downlink decoding information (DDI) reporting. A WTRU may receive a downlink transmission 305. The downlink transmission may be received from a network node (e.g., a gNB). The downlink transmission may be a scheduled downlink transmission, where the WTRU may receive a downlink control information (DCI) that schedules the downlink transmission and the WTRU receives the scheduled downlink transmission in resources based on the DCI. The WTRU may receive the DCI from the gNB.

The WTRU may decode 310 the received downlink transmission. The WTRU may determine downlink decoding information (DDI) 315 (e.g., determine the content of the DDI). The DDI may include one or more of the following: a HARQ-ACK of the received downlink transmission (i.e., ACK or NACK); a HARQ process identification (ID); a new data indicator (NDI) of the received downlink transmission; a transmission time of the received downlink transmission (e.g., an offset from a reference slot); and/or at least one measurement. The at least one measurement may comprise, for example, one or more of: a channel quality indicator (CQI), signal to interference plus noise ratio (SINR), reference signal received power (RSRP) of the downlink transmission or a portion of the downlink transmission (e.g., PDSCH demodulation reference signal (DMRS)) or another downlink transmission (e.g., a channel state information (CSI)-reference signal (RS) that may be near in time and/or frequency of the downlink transmission).

The WTRU may determine to report the DDI 320 (e.g. send a DDI report) to the gNB. The WTRU may determine to report the DDI based one or more conditions or events. The WTRU may determine to report the DDI based on whether the WTRU receives an indication from the gNB requesting a DDI report. The indication requesting a DDI report may be received in the DCI scheduling the downlink the transmission or another DCI. The WTRU may determine to report the DDI based a decoding outcome (e.g., HARQ ACK or HARQ NACK) of the downlink transmission. The WTRU may determine to report the DDI based on whether a measurement (e.g., a measured SINR) during the downlink transmission is above a configured threshold value. The WTRU may determine to report the DDI based on whether a number of retransmissions for or associated with the HARQ process ID is below a configured threshold. The WTRU may determine to report the DDI based on whether a priority associated with the received downlink transmission is above threshold.

The WTRU may send a request for an uplink resource or resources to send the DDI report 325 (e.g., send a message to the gNB indicating a request for uplink resources to send the DDI report). The WTRU may send the request for an uplink resource in response to not having or not receiving an allocation of uplink resources for sending the DDI report.

The WTRU may receive a message 330 (e.g. a DCI) that schedules or allocates one or more uplink resources for sending the DDI report. The WTRU may send the DDI report 335 in the allocated uplink resources for the DDI report.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU), the method comprising:
receiving a downlink transmission;
decoding the downlink transmission;
determining downlink decoding information (DDI) of the decoded downlink transmission, wherein the DDI includes at least a transmission time of the received downlink transmission;
determining to send a DDI report based on at least a priority associated with the downlink transmission, wherein the DDI report comprises the DDI;
sending a request for uplink resources for sending the DDI report;
receiving an allocation of uplink resources for sending the DDI report; and
sending the DDI report in the allocated uplink resources.

2. The method of claim 1, wherein the downlink transmission is received over a physical downlink shared channel (PDSCH), a physical downlink control channel (PDCCH), or a physical broadcast channel (PBCH).

3. The method of claim 1, wherein the determining to send the DDI report is based on a condition that the priority associated with the downlink transmission is above a configured threshold.

4. The method of claim 1, wherein the determining to send a DDI report is further based on at least one of: a number of retransmissions of the downlink transmission; channel conditions during the downlink transmission; a received indication requesting the DDI report; a downlink transmission decoding outcome; a measured signal to interference plus noise ratio (SINR) during the downlink transmission being greater than a first threshold value; or a number of retransmissions associated with a HARQ process identification (ID) being less than a second threshold.

5. The method of claim 1, further comprising receiving a downlink control information (DCI) that schedules the downlink transmission.

6. The method of claim 1, wherein the DDI further includes at least one of: hybrid automatic repeat request (HARQ) acknowledgment information regarding the downlink transmission; a HARQ process identification (ID); a new data indicator; or a measurement of the downlink transmission.

7. The method of claim 1, wherein the transmission time of the received downlink transmission comprises an offset from a reference slot.

8. The method of claim 1, further comprising:
storing the DDI based on one or more of: whether the downlink transmission is control information; a priority of the downlink transmission; a number of retransmissions of the downlink transmission; channel conditions during the downlink transmission; or whether a DDI value is within a configured range.

9. The method of claim 1, further comprising:
receiving a plurality of downlink transmissions; and
grouping a decoding status of the plurality of downlink transmissions into a single DDI.

10. The method of claim 1, further comprising:
determining an importance of a DDI, based on at least one of: a latency budget, a priority of received data, a decoding error rate, a number of decoding errors, an application associated with the received data, an importance indication of a received transport block, code block, or code block group; or whether HARQ is enabled or disabled; and
wherein the determining to send the DDI report is further based on the determined importance of the DDI.

11. A wireless transmit/receive unit (WTRU) comprising:
a receiver;
a transmitter; and
a processor, wherein:
the receiver is configured to receive a downlink transmission;
the processor is configured to decode the downlink transmission;
the processor is further configured to determine downlink decoding information (DDI) of the decoded downlink transmission, wherein the DDI includes at least a transmission time of the received downlink transmission;
the processor is further configured to determine to send a DDI report based on at least a priority associated with the downlink transmission, wherein the DDI report comprises the DDI;
the transmitter is configured to send a request for uplink resources for sending the DDI report;
the receiver is further configured to receive an allocation of uplink resources for sending the DDI report; and
the transmitter is further configured to send the DDI report in the allocated uplink resources.

12. The WTRU of claim 11, wherein the downlink transmission is received over a physical downlink shared channel (PDSCH), a physical downlink control channel (PDCCH), or a physical broadcast channel (PBCH).

13. The WTRU of claim 11, wherein the processor is further configured to determine to send the DDI report is based on a condition that the priority associated with the downlink transmission is above a configured threshold.

14. The WTRU of claim 11, wherein the processor is further configured to determine to send a DDI report further based on at least one of: a number of retransmissions of the downlink transmission; channel conditions during the downlink transmission; a received indication requesting the DDI report; a downlink transmission decoding outcome; a measured signal to interference plus noise ratio (SINR) during the downlink transmission being greater than a first threshold value; or a number of retransmissions associated with a HARQ process identification (ID) being less than a second threshold.

15. The WTRU of claim 11, wherein the receiver is further configured to receive a downlink control information (DCI) that schedules the downlink transmission.

16. The WTRU of claim 11, wherein the DDI further includes at least one of: hybrid automatic repeat request (HARQ) acknowledgment information regarding the downlink transmission; a HARQ process identification (ID); a new data indicator; or a measurement of the downlink transmission.

17. The WTRU of claim 11, wherein the transmission time of the received downlink transmission comprises an offset from a reference slot.

18. The WTRU of claim 11, wherein the processor is further configured to store the DDI based on one or more of: whether the downlink transmission is control information; a priority of the downlink transmission; a number of retransmissions of the downlink transmission; channel conditions during the downlink transmission; or whether a DDI value is within a configured range.

19. The WTRU of claim 11, wherein:
the receiver is further configured to receive a plurality of downlink transmissions; and
the processor is further configured to group a decoding status of the plurality of downlink transmissions into a single DDI.

20. The WTRU of claim 11, wherein:
the processor is further configured to determine an importance of a DDI, based on at least one of: a latency budget, a priority of received data, a decoding error rate, a number of decoding errors, an application associated with the received data, an importance indication of a received transport block, code block, or code block group; or whether HARQ is enabled or disabled; and
the processor is further configured to determine to send the DDI report based on the determined importance of the DDI.
